(19) United States
(12) Patent Application Publication
(10) Pub. No.: US 2009/0154488 A1
(43) Pub. Date: Jun. 18, 2009

(54) METHODS AND APPARATUS FOR SERVICE PROTECTED RANGING IN A PON

(76) Inventors: Moshe Oron, San Rafael, CA (US); Christophe P. Leroy, Chula Vista, CA (US)

Correspondence Address: TIPS GROUP;c/o Intellevate LLC, P. O. BOX 52050, Minneapolis, MN, 55402, US

(21) Appl. No.: 11/959,262

(22) Filed: Dec. 18, 2007

(51) Int. Cl. H04L 12/43

(52) U.S. Cl. 370/458

(57) ABSTRACT

In various example embodiments, a system, method and apparatus are provided for assuring that a ranging process on a PON does not affect real-time services. In an example embodiment, a method is provided. The method includes designating a real-time frame every R frames in a communications system. The method also includes designating frames intervening between real-time frames as non-real-time frames. The method may further include determining a quiet zone is needed for detection of network equipment. Moreover, the method may include scheduling a quiet zone of one or more consecutive non-real-time frames. Additionally, the method may include receiving ranging signals from the network equipment during the quiet zone.

### BACKGROUND

In general, networks much improve life for people. Networks provide for near instantaneous communication between people and/or machines, facilitating information sharing (e.g. business or social conversations) and transactions (e.g. banking, information sharing) which are a part of the fabric of everyday life. However, maintaining such networks presents challenges.

A communications network which operates in real-world conditions typically involves flexibility. Some equipment may need periodic maintenance, connections may be severed, and changes in network topology may occur for various other reasons as well. Thus, maintaining network operation during changes in topology, or basic connections or disconnections of equipment, becomes an important part of network operation generally.

Another important part of network operation in a communications network is providing appropriate levels of service for different transmissions. Some transmissions are aimed at getting data from point A to point B in a reasonably timely fashion, that is tolerant of some delays. Such transmissions are typically non-real-time transmissions. Other transmissions require a minimum level of throughput on a periodic, real-time basis. An example of such a transmission is instantaneous (essentially) voice communication (e.g. people communicating via telephone). In such transmissions, real-time transmission of data is important, and gaps in real-time transmission of data often result in gaps in service (e.g. silence, dropouts, or interference).

### SUMMARY

In various example embodiments, a system, method and apparatus are provided for service protected ranging in a PON. In an example embodiment, a method is provided. The method includes receiving real-time data in a real-time frame every Rth frame. The method may further include receiving non-real-time data in frames intervening between real-time frames. The method may also include determining a quiet zone is needed for detection of network equipment. The method may include scheduling a quiet zone on one or more frames intervening between real-time frames. The method may further include receiving ranging signals from the network equipment during the quiet time.

In an alternate example embodiment, another method is provided. The method includes designating a real-time frame every R frames in a communications system. The method may also include designating frames intervening between real-time frames as non-real-time frames. The method may further include determining a quiet zone is needed for detection of network equipment. Moreover, the method may include scheduling a quiet zone during one or more consecutive non-real-time frames. Additionally, the method may include receiving ranging signals from the network equipment during the quiet time.

### BRIEF DESCRIPTION OF THE DRAWINGS

The accompanying illustrations provide illustrations of various embodiments of the invention, and should be understood as providing examples of the invention, rather than limiting the invention.

FIG. 1 illustrates an example embodiment of a PON (passive optical network).

FIG. 2 illustrates an example embodiment of a process of adding equipment to a PON.

FIG. 3 illustrates implementation of a quiet zone without regard to data transmission characteristics.

FIG. 4 illustrates implementation of a quiet zone during non-real-time data frames.

FIG. 5 illustrates signals received in the example embodiment of a PON of FIG. 1.

FIG. 6 illustrates an example embodiment of an OLT (optical line terminal) which may implement a process of adding equipment to a PON.

### DETAILED DESCRIPTION

In various example embodiments, a system, method and apparatus are provided for service protected ranging in a PON. The embodiments described herein provide examples of embodiments of the invention. Thus, the example embodiments should be understood as providing illustrations of the invention rather than limitations on the invention.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one example embodiment of the invention. The appearances of the phrase “in one embodiment” in various places in the specification are not necessarily all referring to the same example embodiment, nor are separate or alternative example embodiments mutually exclusive of other example embodiments.

In one example embodiment, a method is provided. The method includes transmitting real-time data in a real-time frame every Rth frame. The method may further include transmitting non-real-time data in frames intervening between real-time frames. The method may also include determining a quiet zone is needed for detection of network equipment. The method may include scheduling a quiet zone of one or more frames intervening between real-time frames. The method may further include receiving ranging signals from the network equipment during the quiet zone.

In an alternate example embodiment, another method is provided. The method includes designating a real-time frame every R frames in a PON communications system. The method may also include designating frames intervening between real-time frames as non-real-time frames. The method may further include determining a quiet zone is needed for detection of network equipment. Moreover, the method may include scheduling a quiet zone of one or more consecutive non-real-time frames. Additionally, the method may include receiving ranging signals from the network equipment during the quiet zone.

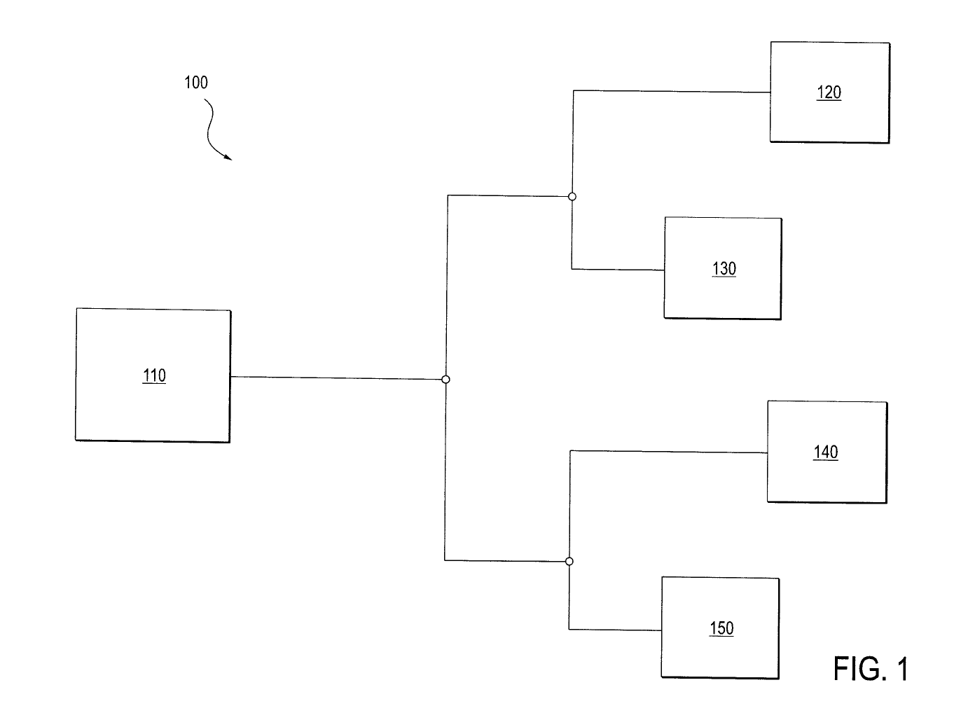

In various example embodiments, the goal of allowing for changing network configurations and topology is met, while allowing for generally steady and effective transmission of real-time data over the network. FIG. 1 illustrates an example embodiment of a PON (passive optical network). PON 100 is illustrated with a central office and a variety of terminal facilities. In particular, an OLT (optical line terminal) 110 can provide functionality at a central office. The OLT 110 represents a device that masters the PON network which steers data to various terminal destinations on the network 100. Coupled to OLT 110 are ONTs (optical network terminals) 120, 130, 140 and 150. These may provide terminal destinations, or may provide a gateway to actual terminal destinations in various example embodiments of such a network. Four ONTs are shown. However, the number of ONTs coupled to a single OLT is not limited to four. For example, 32 or 64 ONTs may be coupled to a single OLT, with each device sending and receiving network traffic along the intervening optical network.

The process of installing new ONTs on a PON might affect service to ONTs already operational on the same network. A PON network such as BPON (Broadband PON) or GPON (Gigabit PON) can be a shared media that employs TDMA in the upstream direction. Traffic from different ONTs can be multiplexed by programming each ONT with an equalization delay factor that adjusts the timing of the ONT transmission to account for distance differences. However, when a new ONT is installed, the OLT does not yet know its distance. In order to measure it during the ONT ranging process, the OLT must grant the ONT transmission of a special packet. In order to ensure that this transmission does not collide with existing ONT transmissions, the OLT enforces a “quiet zone”, that is, halts any traffic upstream for a duration that would allow the new ONT to transmit from any distance it may be in within the allowed range. For example, for the 20 km range the quiet window size may be limited to 250 microseconds. PONs that operate in a longer range would have a proportionally larger quiet zone. In a single ranging process a few quiet-zones may be enforced.

Real-time services that require constant rate such as voice or TDM traffic usually get scheduled in fixed intervals, to minimize jitter and best emulate the behavior of a TDM transport link. Therefore, when a quiet zone is enforced, scheduled transmission of a real-time service packet (real-time data) may be overridden by the quiet zone, and either be skipped or delayed. This increases the jitter on the service, and might even cause packet loss when many quiet zones are opened within a short time. Thus, it may be useful to avoid quiet zones during transmission of real-time data.

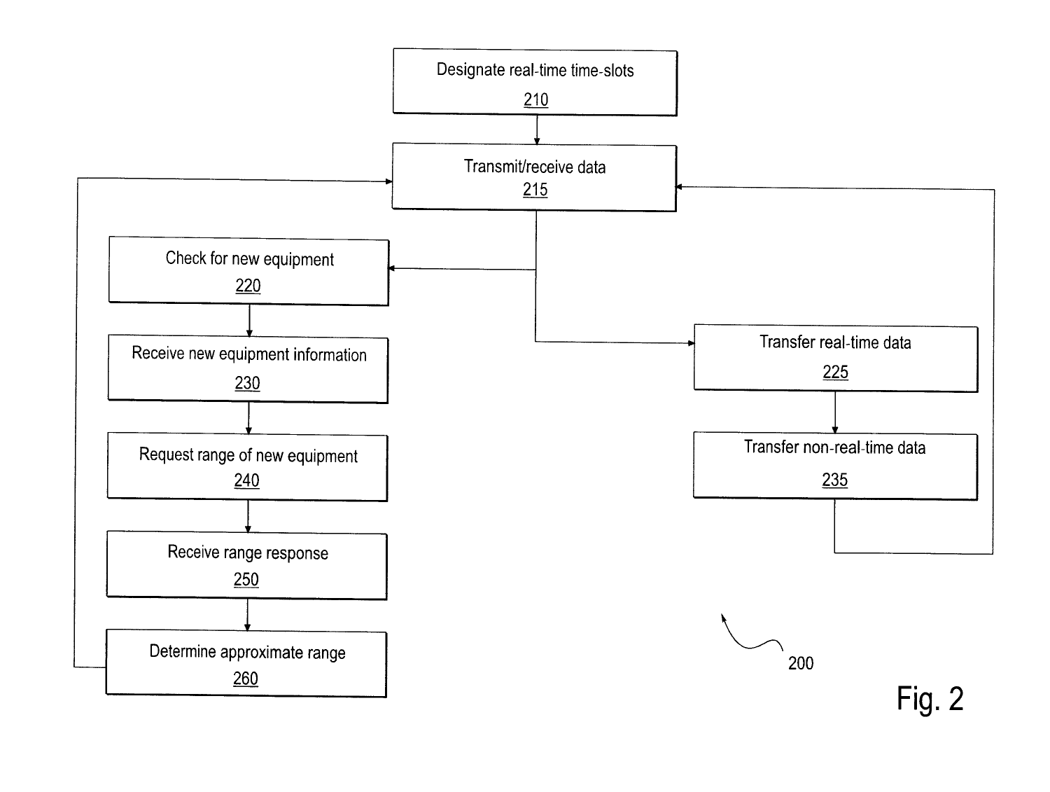

FIG. 2 illustrates an example embodiment of a process of adding equipment to a PON. Process 200 provides a process for both normal operation and for operation when network topology changes. Process 200 and other processes of this document are implemented as a set of modules, which may be process modules or operations, software modules with associated functions or effects, hardware modules designed to fulfill the process operations, or some combination of the various types of modules, for example. The modules of process 200 and other processes described herein may be rearranged, such as in a parallel or serial fashion, and may be reordered, combined, or subdivided in various example embodiments.

Process 200 includes operating the network normally by transceiving (transmitting and/or receiving) real-time and non-real-time data. Process 200 further includes checking for new equipment, receiving new equipment identification, requesting range information, receiving a ranging response, and determining an approximate equalization delay for the new equipment. Note that new equipment may be actual added equipment, or new equipment in the sense that the equipment was not attached to the network moments before (such as due to maintenance for example).

Process 200 initiates at module 210 with designation of real-time frames within periodic transmissions. Thus, every R frames a real-time frame may be designated, allowing for reservation of bandwidth for real-time transmission. At module 215, data is transmitted and received as part of normal network operation. This may be further illustrated by modules 225 and 235. In normal operation, real-time data is transmitted during real-time frames at module 225. During intervening frames, non-real-time data is transmitted at module 235.

On a regular basis, the network may switch to a mode involving checking for new ONT equipment and this mode may be further illustrated by modules 220-260. Not shown is a decision point where a timer may expire or a signal may arrive, triggering this event. In one example embodiment, periodic checks for new ONTs occur on the order of once per second. At module 220, a new ONT is checked for, by requesting information from the new ONT (or any new equipment) and designating a quiet zone. At module 230, any new ONT responds with information about the ONT. This response may not be synchronized with network operations in some example embodiments, due to unknown transmission delays.

To determine transmission delays, at module 240, messages are exchanged with the new ONT, while the network is essentially halted by designating a quiet period. The quiet period is a period in which no device is supposed to transmit on the network, and transmissions will be ignored. This quiet period allows an OLT to listen for data from new ONTs. At module 250, the OLT receives a ranging response from the new ONT. From this response, at module 260, the OLT determines the effective range (or equalization delay) for the new ONT, and may now assign transmission frames for the new ONT, for example.

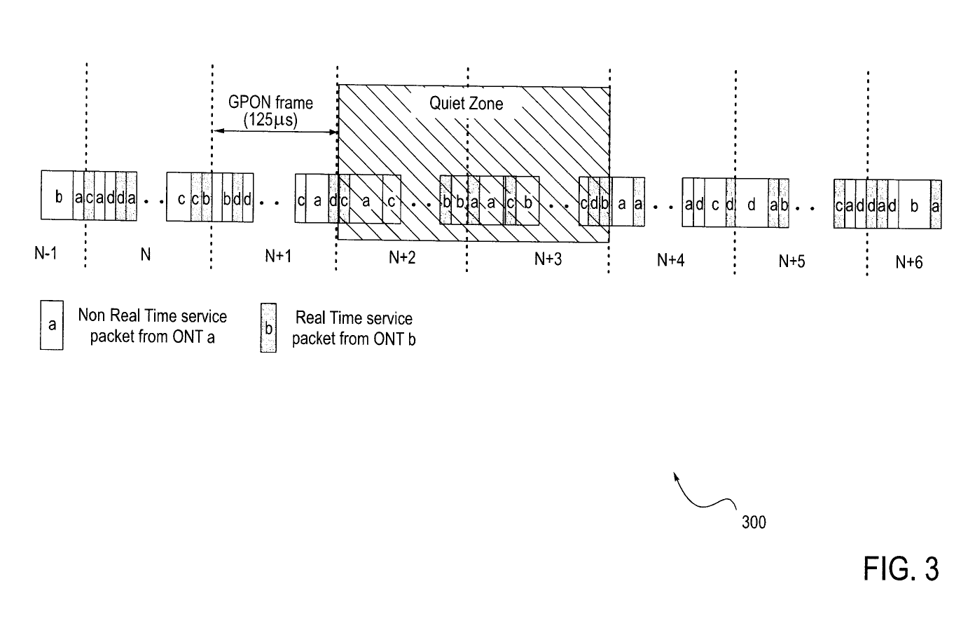

Designating a quiet zone is a tax on the system. It requires cycles of network operation when no data can be transmitted (no transmitter/ONT is granted permission to transmit). FIG. 3 illustrates implementation of a quiet zone without regard to data transmission characteristics. As can be seen in timeline 300, some transmission allocations are lost during the quiet zone. In particular, real-time data transmissions are lost. This quiet zone is designated in an example embodiment where no transmissions are allowed. Thus, planned real-time data transmission are delayed or canceled. This may increase delay and delay variation for real-time services which is undesirable.

Two techniques are used to address this problem during quiet zones:

Compensation: After a quite-zone is issued the OLT performs an assessment; that is, it finds out which real-time services were affected and generates an immediate additional allocation for those services This is a complex method that may create some jitter. It also may limit the frequency of subsequent quiet zones.

Over-allocation: With this method the bandwidth allocated to real-time services is slightly increased to compensate for potential quiet-zones. When a quiet zone occurs, the lost packets are buffered and eventually the buffer will empty since the granting rate is higher than the packet generation rate. This method is simpler than compensation, but still may create jitter, and also may waste bandwidth. A variant of this method involves data services (e.g. high-speed Internet access) mixed in the same Transmission Container (Tcont) with real-time services. This may avoid the bandwidth waste but may worsen jitter behavior.

Hence, in these methods planned real-time grants for service packets may be lost, and thereby there is adjustment to the scheduling after the fact.

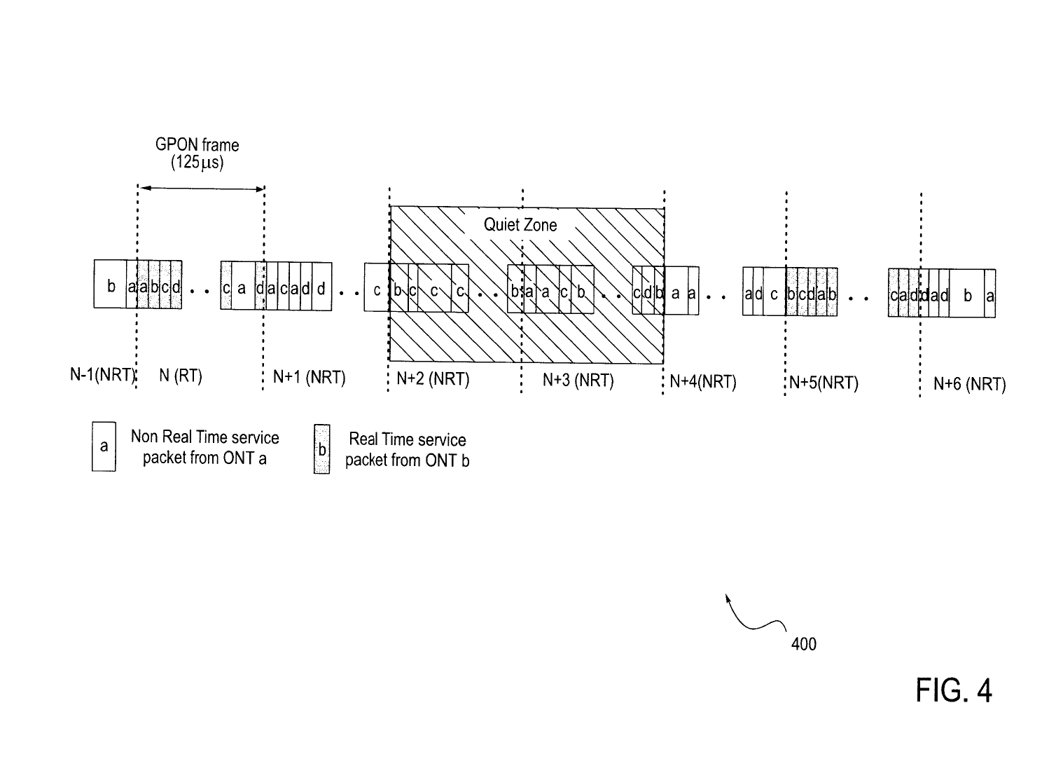

An alternative to the illustrated situation of FIG. 3 is that of FIG. 4. FIG. 4 illustrates implementation of a quiet zone during non-real-time data frames. With frames designated for real-time and non-real-time data, the quiet zone may be designated for non-real-time frames. Non-real-time data may be expected to be data for which a reasonable delay in packet transmission is acceptable and does not disrupt the service. Thus, a quiet zone is designated during frames N+2 and N+3 (two non-real-time frames), and no real-time data is expected to be lost. In this example, a real-time frame is designated every 5 (R) frames. However, different R values may be used, and R values may range between 4 and 16, inclusive, for example. Additionally, each frame in this example embodiment is 125 μs wide, so a two frame quiet zone allows for a 250 μs quiet zone.

One implementation (example embodiment) in particular includes the following features:

a) Transmission Container (Tcont) Architecture: The Tcont scheme employed by the OLT and ONT is per-CoS Tcont. More specifically, all constant rate real-time services are isolated to one or two type-1 Tconts on each ONT. The allocation for those type-1 Tconts is fixed (not dynamic), and may be performed at the accurate constant rate required for the service. A Tcont in this instance is a packet sent in a time-controlled protocol. The Tcont may have various different types, and type 1 is designated for real-time services. In a four service architecture, the other services may be data, premium (potentially a real-time type) and control, for example.

b) Bandwidth Allocation Function: The Upstream transmission on a PON includes a sequence of frames each in a length of 125 microseconds. The method classifies each frame in the sequence as either real-time (RT) or non-real-time (NRT), where granting of real-time services must only occur in RT frames. An RT frame may also carry non-real-time services. The OLT uses a configured frequency R for designation of RT frames, such that every Rth frame is RT and all the rest are NRT. The value of R may be based on the rough expected capacity of RT services, and on the required packet rate for the services. For example, R could be between 4 and 16. This translates to a frequency of 0.5-2 milliseconds. This allows sending a stream of packets of certain size one every R frames (or every second R frame etc), forming a relatively constant service rate. The packet frequency in the range of 0.5-2 milliseconds should be adequate to transport most constant rate services.

c) Ranging function. The ranging function can be independent of the bandwidth allocation function. However in this example embodiment, it is aware of the frame classification. Hence, when a ranging quiet-zone is needed it will be scheduled only on NRT frames, that is, on the “space” (intervening frames) between two adjacent RT frames. With an R value of 4 this allows 375 microseconds quiet zones (ranging of over 30 km). Other R values and ranges may be appropriate for different expected frequencies and frame sizes.

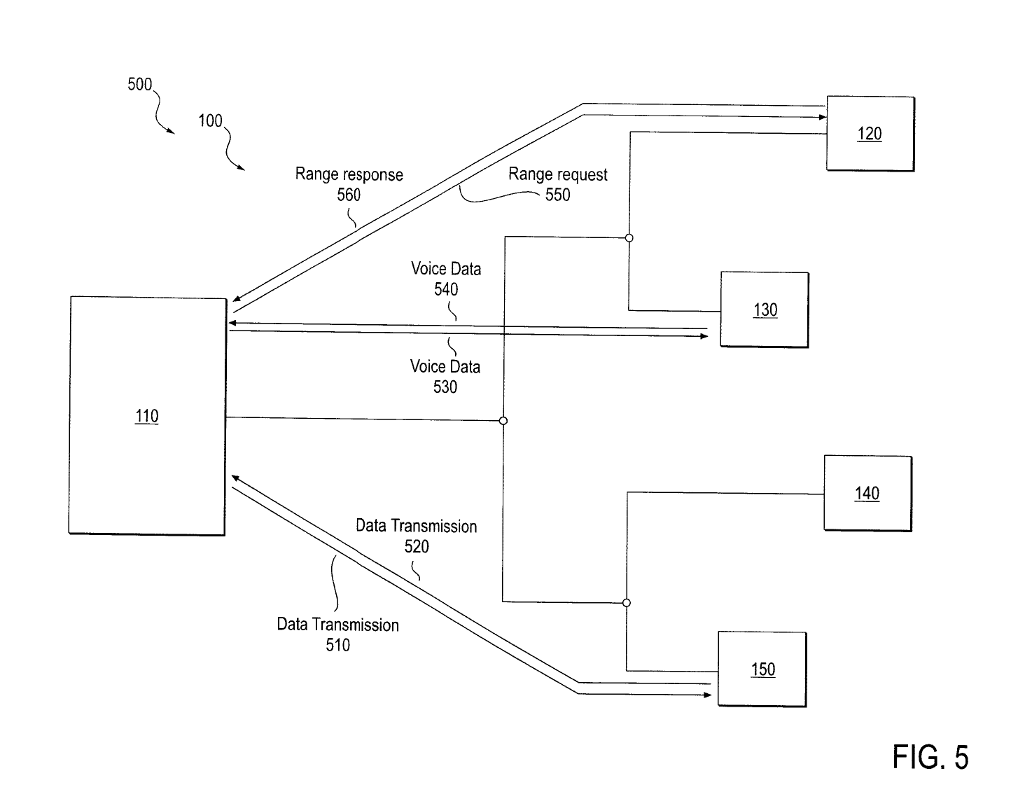

To see the effect of a quiet zone on signals in a PON, consider the illustration of FIG. 5. FIG. 5 illustrates signals received in the example embodiment of a PON of FIG. 1. As illustrated, ONT 120 is sending and receiving data signals, ONT 140 is sending and receiving real-time signals (voice data in this illustration), and ONT 150 is sending and receiving ranging signals. OLT 110 sends data transmission 510 to ONT 120 and receives data transmission 520 during non-real-time frames from ONT 120, as designated by OLT 110 in one example embodiment. Similarly, OLT 110 sends voice data 530 to ONT 140 and receives voice data 540 during real-time frames from ONT 140, as designated by OLT 110.

When OLT 110 needs to range ONT 150, it sends a ranging signal 550, and receives a ranging signal 560 from ONT 150 in response. To do this, OLT 110 designates a quiet zone. The quiet zone is designated so that it may affect transmission 520 (non-real-time data), but may not affect voice data transmission 540 (or other real-time data, for example). Once ranging signals 550 and 560 have been transmitted and received, the need for the quiet zone in particular dissipates, allowing a return to normal operation.

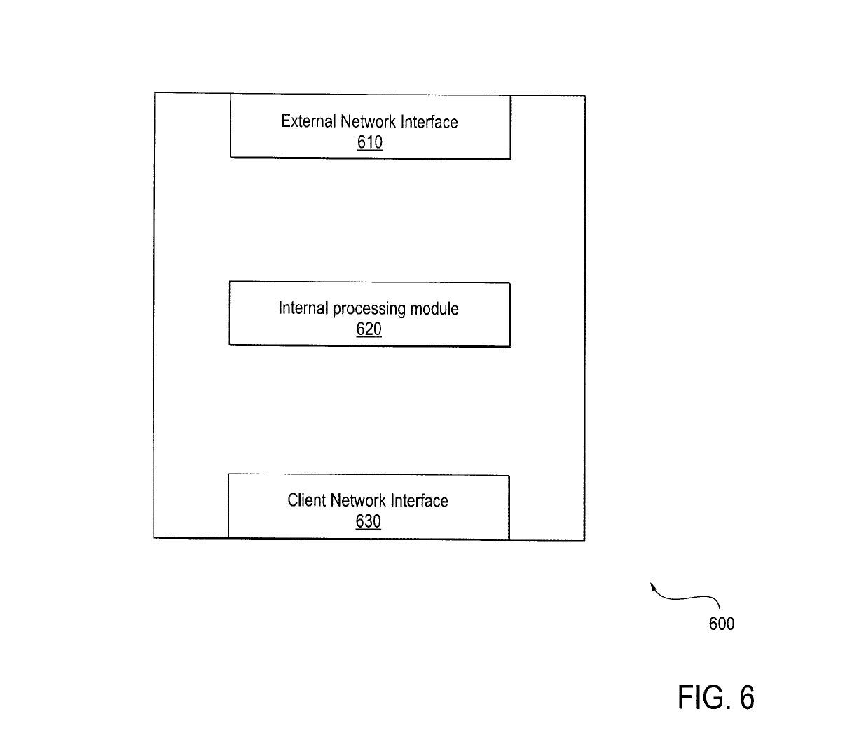

Various different types of equipment may be used in pursuit of implementation of the methods described above. FIG. 6 illustrates an example embodiment of an OLT which may implement a process of adding equipment to a PON. OLT 600 is presented as a generic block diagram to avoid obscuring the present invention. Thus, OLT 600 includes network interfaces (external network interface 610 and PON interface 630) and an internal Core 620. Internal Core module 620 may take on various forms, potentially centered around a switching fabric or network processor, for example, and may include processors, memory, and other components. Thus, internal core module 620 may designate what frames in a TDMA network are real-time, for example, and which frames are non-real-time. This may be responsive to observed conditions, or to predetermined information (e.g. R equals 8 for an example embodiment). Internal processing module 620 may also designate quiet zones and check for equipment as needed.

The OLT 600 is one example of many possible systems which have different architectures. For example, have a switching fabric connected with busses to both the network interface module(s) and all PON interface modules. Another bus may directly connect the processors and memories (often referred to as a memory bus). The buses are sometimes connected together through bridging or switching components that perform any necessary classification, forwarding or routing between different modules, or network processors that perform protocol processing functions on the transported data. Other components in some example embodiments may include longer term storage, typically of a non-volatile nature, such as FLASH memory or a disk drive.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying”0 or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some example embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required operations. The required structure for a variety of these systems is apparent from the description. In addition, the present invention is not described with reference to any particular programming language, and various example embodiments may thus be implemented using a variety of programming languages.

One skilled in the art will appreciate that although specific examples and example embodiments of the system and methods have been described for purposes of illustration, various modifications can be made without deviating from the present invention. For example, example embodiments of the present invention may be applied to many different types of software and operating systems or different types of computers. Moreover, features of one example embodiment may be incorporated into other example embodiments, even where those features are not described together in a single example embodiment within the present document.

What is claimed is:

1. A method, comprising:
receiving real-time data only in real-time frames every Rth frame;
receiving non-real-time data in frames intervening between real-time frames;
determining a quiet zone is needed for detection of ONT network equipment;
scheduling a quiet zone of one or more frames intervening between real-time frames; and
receiving ranging signals from the network equipment during the quiet zone.

2. The method of claim 1, further comprising:
signaling the ONT network equipment to provide the ranging signals during the quiet zone.

3. The method of claim 1, wherein:
R is an integer value between 4 and 16, inclusive; and
each frame is 125 μs.

4. The method of claim 1, wherein:
R is chosen to provide a frequency of real-time data transmission sufficient to meet expected real-time service requirements.

5. The method of claim 1, wherein:
the quiet zone is two consecutive frames.

6. The method of claim 1, wherein:
the quiet zone is chosen to provide time sufficient to receive a signal from the network equipment based on a predetermined maximum range.

7. A method, comprising:
designating a real-time frame every R frames in a communications system;
designating frames intervening between real-time frames as non-real-time frames;
determining a quiet zone is needed for detection of network equipment;
scheduling a quiet zone of one or more consecutive non-real-time frames; and
receiving ranging signals from the network equipment during the quiet zone.

8. The method of claim 7, further comprising:
signaling the network equipment to provide the ranging signals during the quiet zone.

9. The method of claim 8, further comprising:
determining a transmission distance to the network equipment based on an arrival time of the ranging signals.

10. The method of claim 7, wherein:
R is an integer value between 4 and 16, inclusive; and
each frame is on the order of 125 μs.

11. The method of claim 7, wherein:
R is chosen to provide a frequency of real-time data transmission sufficient to meet expected real-time service requirements.

12. The method of claim 11, further comprising:
receiving a representation of expected real-time service requirements.

13. The method of claim 7, wherein:
the quiet zone is two consecutive frames.

14. The method of claim 7, wherein:
the quiet zone is chosen to provide time sufficient to receive a signal from the network equipment based on a predetermined maximum range.

15. The method of claim 14, wherein:
the predetermined maximum range is 20 km.

16. The method of claim 9, wherein:
the network equipment includes newly installed network equipment.

17. The method of claim 9, wherein:
the network equipment includes reactivated network equipment.

18. A machine readable medium embodying instructions, the instructions causing a processor executing the instructions to perform a method, the method comprising:
designating a real-time frame every R frames in a communications system;
designating frames intervening between real-time frames as non-real-time frames;
determining a quiet zone is needed for detection of network equipment;
scheduling a quiet zone of one or more consecutive non-real-time frames; and
receiving ranging signals from the network equipment during the quiet zone.

19. The machine readable medium of claim 18, wherein the instructions further cause the processor to perform a method which further comprises:
signaling the network equipment to provide the ranging signals during the quiet zone.

20. The machine readable medium of claim 19, wherein the instructions further cause the processor to perform a method which further comprises:
determining a transmission distance to the network equipment based on an arrival time of the ranging signals.
